(19) United States
(12) Patent Application Publication
(10) Pub. No.: US 2009/0006338 A1
(43) Pub. Date: Jan. 1, 2009

(54) USER CREATED MOBILE CONTENT

(75) Inventors: Stephen Ives, Swavesey (GB); Stefan Butlin, Cambridge (GB)

Correspondence Address: BARNES & THORNBURG LLP, P.O. BOX 2786, CHICAGO, IL, 60690-2786, US

(73) Assignee: TAPTU LTD., Cambridge (GB)

(21) Appl. No.: 12/147,593

(22) Filed: Jun. 27, 2008

Related U.S. Application Data
(60) Provisional application No. 60/946,729, filed on Jun. 28, 2007.

(51) Int. Cl. G06F 17/30; H04Q 7/22

(52) U.S. Cl. 707/3; 455/414.1; 707/E17.121

(57) ABSTRACT

A search engine (50, 35, 60, 63, 103) interacts (17) with the user while they are accessing (7) an existing online content item to enable the user to create a mobile web version of at least a portion of that existing online content item. The mobile version is stored (37, 63) and indexed (35, 709) as a user created search result, retrievable by the search engine in response to a search query (47). This can produce better results than automated conversion, and thus improve mobile search. The interaction can involve constraining a size and text format of the mobile web version so it can reasonably be viewed on a screen of a hand held mobile device.

### RELATED APPLICATIONS

This application claims the benefit of earlier filed provisional application Ser. No. 60/946,729 filed 28 Jun. 2007 entitled “Method of Enhancing Availability of Mobile Search Results”.

This application also relates to five earlier U.S. patent applications, namely Ser. No. 11/189,312 filed 26 Jul. 2005, published as US 2007/00278329, entitled “processing and sending search results over a wireless network to a mobile device”; Ser. No. 11/232,591, filed Sep. 22, 2005, published as US 2007/0067267 entitled “Systems and methods for managing the display of sponsored links together with search results in a search engine system” claiming priority from UK patent application no. GB0519256.2 of Sep. 21, 2005, published as GB2430507; Ser. No. 11/248,073, filed 11 Oct. 2005, published as US 2007/0067304, entitled “Search using changes in prevalence of content items on the web”; Ser. No. 11/289,078, filed 29 Nov. 2005, published as US 2007/0067305 entitled “Display of search results on mobile device browser with background process”; and U.S. Ser. No. 11/369,025, filed 6 Mar. 2006, published as US2007/0208704 entitled “Packaged mobile search results”. This application also relates to provisional applications:

Ser. No. 60/946,728 filed 28 Jun. 2007 entitled “Ranking Search Results Using a Measure of Buzz”,

Ser. No. 60/946,730 filed 28 Jun. 2007 entitled “Social distance search ranking”

Ser. No. 60/946,726 filed 28 Jun. 2007 entitled “Audio Thumbnail”,

Ser. No. 60/946,727 filed 28 Jun. 2007 entitled “Managing Mobile Search Results”,

Ser. No. 60/946,731 filed 28 Jun. 2007 entitled “Festive Mobile Search Results”.

The contents of these applications are hereby incorporated by reference in their entirety.

### FIELD OF THE INVENTION

This invention relates to systems for creating mobile web versions of online content, and to methods of providing search services, and to methods of using search services, and to corresponding computer programs.

### DESCRIPTION OF THE RELATED ART

Search engines are known for retrieving a list of addresses of documents on the Web relevant to a search keyword or keywords. A search engine is typically a remotely accessible software program which indexes Internet addresses (universal resource locators (“URLs”), usenet, file transfer protocols (“FTPs”), image locations, etc). The list of addresses is typically a list of “hyperlinks” or Internet addresses of information from an index in response to a query. A user query may include a keyword, a list of keywords or a structured query expression, such as Boolean query.

A typical search engine “crawls” the Web by performing a search of the connected computers that store the information and makes a copy of the information in a “web mirror”. This has an index of the keywords in the documents. As any one keyword in the index may be present in hundreds of documents, the index will have for each keyword a list of pointers to these documents, and some way of ranking them by relevance. The documents are ranked by various measures referred to as relevance, usefulness, or value measures. A metasearch engine accepts a search query, sends the query (possibly transformed) to one or more regular search engines, and collects and processes the responses from the regular search engines in order to present a list of documents to the user.

It is known to rank hypertext pages based on intrinsic and extrinsic ranks of the pages based on content and connectivity analysis. Connectivity here means hypertext links to the given page from other pages, called “backlinks” or “inbound links”. These can be weighted by quantity and quality, such as the popularity of the pages having these links. PageRank™ is a static ranking of web pages used as the core of the search engine known by the trademark Google (http://www.google.com).

Search engines for searching the world wide web are well developed for accessing the web from a desktop personal computer (e.g. Google, Yahoo, et al). Mobile devices that are capable of accessing content on the world wide web are being increasingly numerous. Mobile search engines prompt the user for a search term (or terms) and return mobile search results that are currently limited to links to mobile-specific websites and transcoded (automatically adapted) desktop websites. However, mobile web pages designed specifically for the small screen sizes of mobile devices are very few. A mobile web page is defined as a website whose content is rendered using HTML that can be reasonably viewed and navigated within the constrained display and network capabilities of a hand held mobile device or handset. Furthermore, there are only a few very simple search services available to mobile devices. These mobile search services perform poorly for several reasons:
there are not enough mobile-specific pages available to provide relevant pages for most search queries, compared to the number of desktop webpages,
desktop-specific webpages cannot be easily rendered on the limited screen and limited browsers of mobile devices, and
direct translation of desktop-specific webpages to the specific markup language supported by most mobile devices (eg XHTML Basic and XHTML Mobile Profile) is a hard problem, so the number of desktop websites that are successfully adapted by a transcoder is small.

It is known for web developers to submit URLs of new web pages or web sites to search engines or to mobile search engines to ensure the new pages are crawled and thus appear in search results without waiting weeks or months for the crawlers to find the new pages.

### SUMMARY

An object of the invention is to provide improved apparatus or methods. Features of some embodiments of the invention can include:

A system arranged to incorporate content created by a user, the system having a user interface to interact with the user while they are accessing an existing online content item to enable the user to create a mobile web version of at least a portion of that existing online content item, and an indexing part arranged to store and index the user created mobile version as a user created search result, retrievable by the system in response to a search query.

Converting existing online content is a very difficult task to automate, and hence enabling users to create their own mobile versions is likely to produce better results, and thus improve mobile search. By incorporating the user interface and the indexing part in a search engine, the flow of creating and indexing can be made easier and more efficient.

Some other embodiments of the invention can include corresponding methods of providing a search service and methods of using a search service.

Any additional features can be added, and any of the additional features can be combined together and combined with any of the above aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows some steps of operation of an embodiment,

FIG. 2 shows operational steps of another embodiment using browser plug in,

FIG. 3 shows an example involving sharing,

FIG. 4 shows an overview of a system according to an embodiment,

FIG. 5 shows an embodiment for use with a browser,

FIG. 6 shows an embodiment using a search result as source and storing as instructions,

FIG. 7 shows an embodiment having layout control and authentication,

FIG. 8 shows query server actions, and

FIG. 9 shows an example of web collections.

### DESCRIPTION OF THE PREFERRED EMBODIMENTS

Definitions

A corpus is intended to encompass any collection of content items accessible for searching by a computer of a user, or accessible online, such as all or any part of the world wide web, any collection of web pages, any web site or collection of web sites, any database, any collection of data files, audio, image or video files and so on. It can be located anywhere, such as in storage controlled by web servers, in online databases, in a web mirror crawled from the web, in an indexed web collection, in storage associated with an intranet, or local storage in the user's own computing device and so on.

Score can be any kind of score and encompasses for example a count, a weighted count, an average over time, and so on.

Online means accessible by computer over a network and so can encompass accessible via the internet or public telecommunications networks, or via private networks such as corporate intranets.

Content items encompasses web pages, or extracts of web pages, or programs or files such as images, video files, audio files, text files, or parts of or combinations of any of these and so on.

User can encompass human users or services such as meta search services.

Items which are “accessible online” are defined to encompass at least items in pages on websites of the world wide web, items in the deep web (e.g. databases of items accessible by queries through a web page), items available internal company intranets, or any online database including online vendors and marketplaces.

A mobile web version of a content item is intended to encompass a version which is more suited to accessing or consuming on a hand held mobile device with more limited bandwidth, or display, or storage or processing facilities than a typical desktop device. Different types of content items cause different types of difficulties and so can be adapted in different ways to become mobile versions.

Changes in occurrence can mean changes in numbers of occurrences and/or changes in quality or character of the occurrences such as a move of location to a more popular or active site.

Hyperlinks are intended to encompass hypertext, buttons, softkeys or menus or navigation bars or any displayed indication or audible prompt which can be selected by a user to present different content.

The term “comprising” is used as an open ended term, not to exclude further items as well as those listed.

Introduction to Embodiments:

At least some embodiments of this invention address the scarcity of material suitable for displaying in the results of a web search conducted on a mobile device by providing means for users of a search service to submit new content—not just the URL of a new page to be included (which is a well established technique) but to be able to submit the contents of the new candidate search result itself—and in such a manner that the result is “mobile friendly” (i.e. viewable/consumable on the limited network and display capabilities of a mobile device). Other embodiments are concerned with the subsequent sharing of the new search result with not just the search engine it was submitted to, but directly to the desktop and mobile handsets of other users (friends, colleagues etc).

An aspect of the invention provides software, systems (meaning software and hardware to run the software) or an exchange of signals with users, to provide a service for finding or navigating to online content, and prompting the user to create an extract of one or more items of online content, the service being arranged to add the extract to the index of a complementary search service for sending with future search results. Examples of extracts include: travel timetables, directions to postal addresses, food recipes, humorous content, photos, reviews, and so on.

The extract can be suitable for mobile search or in some cases for desktop search. The content item from which the extract is created can be for example pages or other items found in preceding search results (but not sufficiently well presented or ranked in those results), or could be pages of which the user was aware without a search.

Another aspect provides a method of using such a service, by searching or otherwise navigating to online content, and responding to a prompt and creating an extract of one or more items of online content, and sharing the extract with other users. In this aspect the additional step of submitting (or authorising) the extract for use as a future search result is optional. Sharing may take the form of directly sending the extract using for example email or indirectly sending the extract using for example an SMS containing a link to the extract.

Another aspect provides software, systems (meaning software and hardware to run the software) or an exchange of signals with users, to provide a service for prompting the user to create an extract of one or more items of online content where the user can use other (3rd party) systems or software to find the online content. This aspect could be embodied, for example, as a plug-in component to a web browser that uses the current page as the online content from which to prompt for the creation of an extract. In the preferred embodiment of this invention, the search engine (desktop) website is augmented with pages allowing for the creation, submission and sharing of new search results.

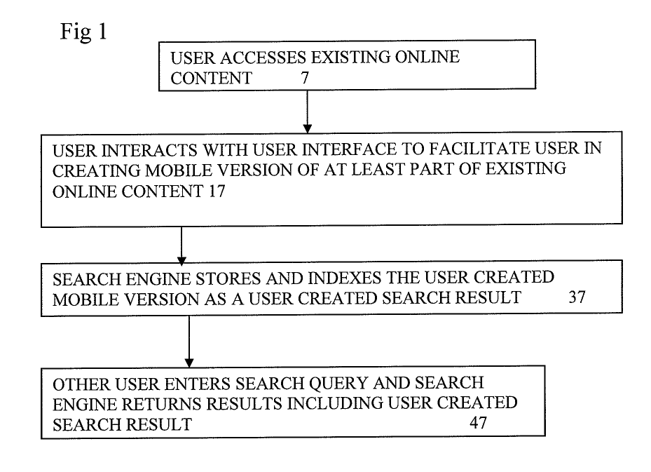

FIG. 1, Some Steps of Operation of an Embodiment

FIG. 1 shows some operational steps of a system according to an embodiment. Other steps can be added as desired. The system can be any kind of system which has search functions, and so can be a search engine for searching online accessible content, or other system which incorporates search engine functions such as indexing and responding to search queries. At step 7, a user accesses existing online content. This can involve any way of accessing such content. The user interacts with a user interface of the system at step 17 to facilitate the user in creating a mobile web version of at least part of the existing content item. The search engine stores and indexes the user created mobile version as a user created search result at step 37. When another user (or conceivably the same user at a later time) enters a search query to the search engine, at step 47 the search engine returns results including user created search results if they are relevant to the search query. The results are sought in a given corpus of suitable material, and the user created results can serve to increase the corpus of suitable material. The content item can be any kind of content item which is not already suited for use as a mobile web search result. The mobile web version can differ in a number of ways from the corresponding source content item.

Additional Features of some Embodiments:

Any features can be added to create further embodiments, some such additional features are set out in dependent claims and some are described in more detail below. The user created search result can be formatted as a portion of a web page, and the user interface be arranged to constrain a size and text format of the mobile web version so that the portion can reasonably be viewed on a screen of a hand held mobile device (in other words is suited to or usable on the screen). It is more convenient for mobile users if the page or an area of text is narrowed so that left or right scrolling is minimized. Text font size may be enlarged to maintain readability. Images may be resized or made into thumbnails which can be expanded by clicking for example. A typical screen size is 4×6 cm or 5×7 cm or 6×9 cm approximately, and often with a “portrait” rather than “landscape” orientation. In other cases the mobile web version may be constrained in other ways, to limit usage of bandwidth or processing or memory resources for example.

The user interface can be arranged to cooperate with a browser of the user to prompt a user to select an extract of a web page being presented by the browser. This can be more convenient for a user than other types of interface which may be envisaged.

In some embodiments, the user interface can be arranged to combine a number of extracts of the existing online content item to form the mobile web version. Another additional feature is the user interface being arranged to enable user control of layout of the extracts in the mobile web version.

The indexing part can be arranged to store the user created search result in the form of instructions to retrieve an online accessible source content item, and to extract a given part of it to recreate the user created search result. This can enable a reduction in storage space required, or enable the mobile version to be up to date, or facilitate on the fly adaptation to user preferences for example.

The indexing part being arranged to store the user created search result as a content summary package. This can be convenient for users and improve their mobile searches. The user interface can be arranged to cooperate with a browser on a device of the user to highlight prospective extracts for the user to select. This can make it easier and quicker for a user.

The system can have a sharing part arranged to enable the user to share the user created content with a given other user. This can make the task more efficient for a user and can provide more incentive for the user to take time to create a mobile version

User Search Result Creation Example

To create a new search result for use with mobile web searches, first the content item such as a web page that the result will be extracted from (or summarized from) is identified (the source page). This page can be identified either by direct entry of its URL, or by offering the user the chance to browse (proxied within a frame or iframe) to a suitable source page.

Once a suitable source page has been identified, the user interface of the creation page allows for objects within the source page to be selected for inclusion in the new search result. One interface for this process involves displaying the source page within a sub-region of the hosting creation page, tracking the mouse over the source content and highlighting the current object. The current object might be a paragraph of text, an image, a heading or any other HTML tag or region. The highlight can be any means of indicating the current area, including modifying the border colour or background colour. So as the mouse tracks over the source page, the most relevant region (or object) is highlighted. If the user then clicks on the current highlighted region, that region (or object) is selected for inclusion in the candidate search result. This is indicated to the user by displaying an output container that is augmented by each successive object so clicked on.

Once sufficient source page objects have been selected for inclusion in the new search result, the user is invited to submit the candidate search result for inclusion in the index of the search engine. Optionally, the user can be prompted to supply one or more keywords (tags) that describe the nature of the submission. These keywords are then included in the meta-data of the new content and included in the index.

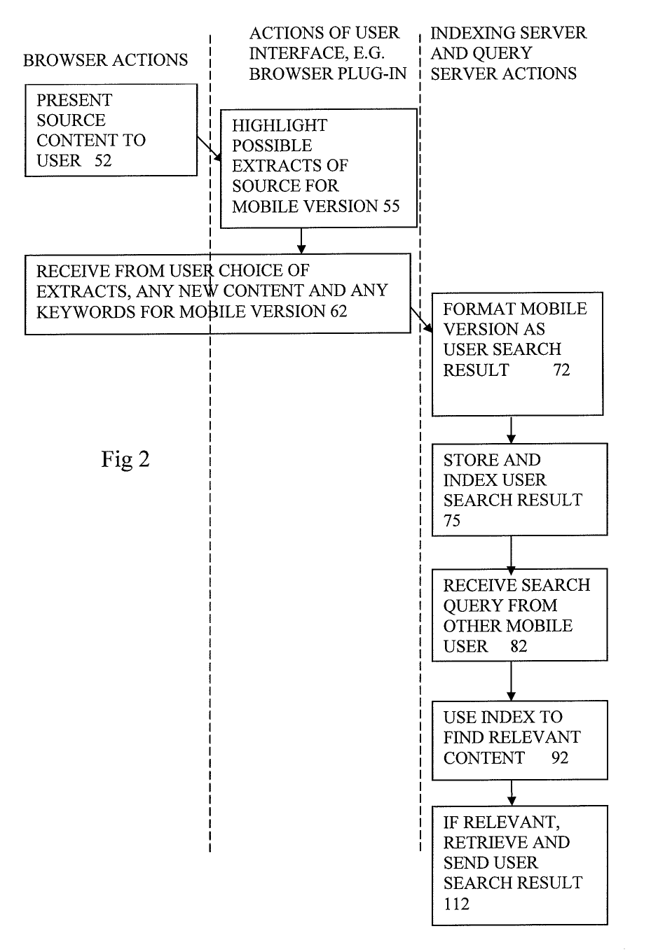

FIG. 2, Operational Steps of Another Embodiment Using Browser Plug In

FIG. 2 shows operational steps of another embodiment involving a browser plug-in as a user interface. Other ways can be envisaged of implementing this, as will be discussed, but this implementation enables user interaction when the user is browsing any website, rather than only when the user is accessing the search service. Actions of the browser are shown in a left hand column. Actions of the user interface, e.g. the browser plug-in are shown in a central column. Actions of an indexing server and query server of the system are shown in a right hand column. The system in this case is distributed, and comprises the plug-in at the user's device and parts of the search engine located on a server or servers of a service provider, typically at different location to the user, and coupled by a network using conventional technology. At step 52, the browser on the user's device presents the original content item to the user. This can be a web page or a multimedia file for example. At step 55, the browser plug in highlights parts of the content item, for example parts of the web page or parts of the multimedia file suitable for use as the mobile web version. This may involve identifying parts of the page, e.g. text paragraph, headings, titles and so on, which typically have more significant information. This can involve using existing transcoding type techniques. The user determines which extracts they are interested in and clicks or inputs their choice in any way at step 62. The user may be given an opportunity to add new material or look for other source documents for example to add more to the mobile web version.

The indexing part then receives the finished mobile version, formats it as a search result at step 72 and stores and indexes it at step 75, following established search engine practice. Hence when a later search query is received from another user at step 82, typically a mobile user, the search engine query server uses the index to find relevant content at step 92. If relevant to that search query, the user search result is retrieved and sent to the user as part of the search results.

When such a new item of content is presented in the results of a search, the search engine can optionally provide a link to the source page from which the content was extracted. Further, this link could be direct or could be indirect via a transcoding service.

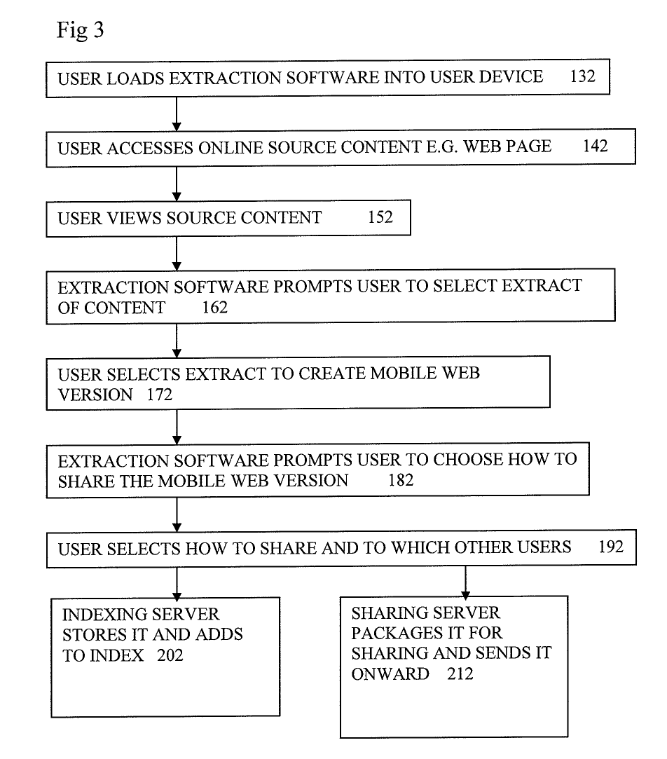

FIG. 3, Example Involving Sharing

At this stage, as well as submitting the new content fragment (candidate search result) to the search engine, the user may also wish to immediately share the item with another user. This can be accomplished by offering the user means to provide the email addresses or mobile phone number of other users for example.

FIG. 3 shows steps in the operation of an embodiment involving sharing. In the example shown in FIG. 3, the user interface involves extraction software on a user's device, such as a browser plug in, though of course other ways of implementing the user interface can be envisaged. The user loads extraction software from a service providers website into the user's device at step 132 using conventional techniques that need not be described here in more detail. At step 142, the user accesses a source content item such as a web page. The user views the web page at step 152, and the extraction software operates to prompt the user to select an extract at step 162. This can involve displaying a menu or highlighting or outlining portions, or any other type of prompt. The user responds by selecting an extract of the web page as described above, and optionally adding further extracts or files or other additional information at step 172, to form the mobile web version. The amount and types of interaction offered can depend on the context of the user's browsing and the capabilities of the user device. For example if the user is at a typical desktop computing device with mouse input, it is typically easier to type and cut and paste. If browsing on a mobile device then such editing is typically less convenient, and so less interaction or simpler interaction may be offered.

The extraction software then offers the user a chance to share the mobile web version at step 182. This may involve a number of options, depending on how many types of sharing are offered and on the user device and user preferences and so on. The user selects how to share and with whom at step 192. Depending on the choices made, the indexing server may store and index the mobile web version as a user created search result. A sharing server can be used to package the mobile web version for sharing and sends it onward at step 212. For email sharing, the search engine can construct an email containing either the item itself or a link (URL) to the item. For mobile phone sharing, the search engine can construct an SMS containing a link to the item. It is beneficial, especially in the case of SMS, to keep URLs to these content items as short as possible. This allows the user space to add a custom message and, in the case of email, helps avoid line breaks reformatting the URL.

Alternatively, the new item can be shared by supplying one or more keywords (on the submission page) that are likely to be unique and then by communicating those keywords to other users for use in a normal search on the search engine.

Other ways of implementing such sharing can be envisaged and reference is made to above referenced copending application entitled “Managing Mobile Search Results”, for further information.

Graphical User Interface Example

In another embodiment of this invention, the user interface for creating new content items, a drag and drop style interface can be provided to more intuitively “pick up” objects from the source page and “drop” them onto an output container. The output container displays the accumulating collection of content. Content in the output container can also be removed by dragging objects back out.

In another embodiment, the region that can be clicked on (or dragged and dropped) is highlighted in advance, i.e. the source page is changed to put borders (or other region defining cues). The user then can see which regions are selectable without exploring with the mouse.

In another embodiment, the user interface for creating new content allows for control of the layout of new content. As described above, only the order objects are added in can be used to control the layout. However, it would be beneficial to the user to be able to modify how the selected objects are arranged. The interface for this re-layout could be drag and drop again, or could be via context-sensitive menus on each object offering new layout options (for example, options could be provided to right-align, top-align, distribute in table etc).

In another embodiment, the user could be required to supply new content as raw HTML in a text input box. Alternatively, the user could have the option to augment mouse-selected content with hand-crafted HTML or items of text.

A consequence of providing the graphical user interface method of creating the new content is that the search engine can later adapt the item to best display it given the varying capabilities of mobile handsets and their browsers. This is done by storing the supplied content objects in a format that has no (or is very light on) presentation information. For example, an item might be encoded as a paragraph of text followed by an image. Using common templating techniques (such as XSLT or many other technologies) such content can then be rendered (converted into HTML) appropriate for the current device. If some layout information is needed (for example, that the image should be aligned top-right on the page with the text in a paragraph below using the full width), then this simple layout can be encoded in a device-neutral representation (possibly using an XML schema) for later re-purposing according to the calling device.

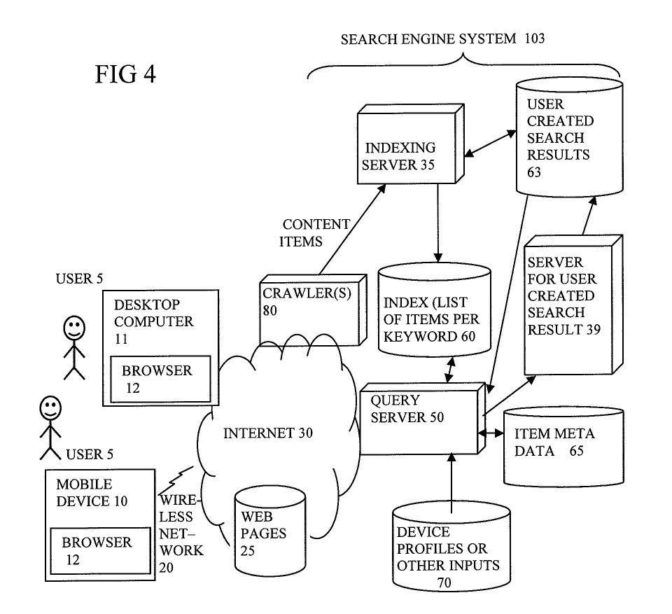

FIG. 4, Overview of System According to an Embodiment

In some embodiments, a mobile search engine is implemented consisting of the usual components of a search engine: a front end comprising a query server, indexer and indexes, and back-end in the form of crawler components that collect URLs to mobile pages. Examples of suitable components are shown in more detail in the above referenced related applications, particularly:

Packaged Mobile Search Results—U.S. application Ser. No. 11/369025;

Display Search Results on Mobile Device Browser With Background Process—U.S. application Ser. No. 11/289078;

Processing and Sending Search Results Over Wireless Network to a Mobile Device—U.S. application Ser. No. 11/189312.

The front end in the form of the query server provides a mobile friendly interface (i.e. HTML that can be reasonably viewed and navigated on a mobile handset). The back-end in the form of the crawler identifies as many mobile sites and pages as it can find and accumulate over time.

Although described in the context of improving mobile search, some embodiments can also be applied to desktop pages and sites. In this case, the preferred embodiment is as above, except that the crawlers are not limited to mobile web sites and the user interface is a normal HTML front end.

Any of the various features described above can be combined with any other of the features and with other known features. It is particularly useful to combine the features described above with features of mobile searches as described in preceding applications by the present applicants, referenced above.

The overall topology of an embodiment of the invention is illustrated in FIG. 4. This or other topologies can be used to implement the embodiments described above. In FIG. 4, a query server 50 and web crawler 80 are connected to the Internet 30 (and implemented as Web servers—for the purposes of this diagram the web servers are integral to the query and web crawler servers). The web crawler spiders the World Wide Web to access web pages 25 and typically builds up a web mirror database (not shown) of locally-cached web pages. The portion of the web reached, or the web mirror, can be regarded as the corpus. The crawler can control which websites are revisited and how often, to keep up to date with changes in the corpuses. An index server 35 builds an index 60 of the web pages from this web mirror.

These parts form a search engine system 103. This system can be formed of many servers and databases distributed across a network, or in principle they can be consolidated at a single location or machine. The term search engine can refer to the front end, which is the query server in this case, and some, all or none of the back end parts used by the query server, whose functions can be replaced with calls to external services.

A plurality of users 5 connected to the Internet via desktop computers 11 or mobile devices 10 can make searches via the query server. The users making searches (‘mobile users’) on mobile devices are connected to a wireless network 20 managed by a network operator, which is in turn connected to the Internet via a WAP gateway, IP router or other similar device (not shown explicitly). The search results sent to the users by the query server can be tailored to preferences of the user or to characteristics of their device. Such user preferences or device profiles and any other inputs can be stored in a database 70, coupled to the query server.

Many variations are envisaged, for example the content items can be elsewhere than the world wide web, and the mentions counter or index servers could take content from its source rather than the web mirror and so on.

The query server 50 can operate to carry out some of the user interface functions described above, or to cooperate with software such as the extraction software in the form of a browser plug-in at the user device as described above with reference to FIG. 2. The mobile web version can be passed by the query server to a server 39 for the user created search results. This can optionally be used to control the interaction with the user and to carry out any formatting of the mobile web version to create a user search result to be stored in database 63 of user created search results and indexed by indexing server 35. The retrieval of the user search result if found relevant to a search query, can be carried out by the query server, as described below and following established search engine techniques.

Description of Devices

The user can access the search engine from any kind of computing device, including desktop, laptop and hand held computers. Mobile users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or micro browser applications e.g. Openwave™, Access™, Opera™ browsers, which can access web pages across the Internet. These may be normal HTML web pages, or they may be pages formatted specifically for mobile devices using various subsets and variants of HTML, including cHTML, DHTML, XHTML, XHTML Basic and XHTML Mobile Profile. The browsers allow the users to click on hyperlinks within web pages which contain URLs (uniform resource locators) which direct the browser to retrieve a new web page.

Description of Servers

There are four main types of server that are envisaged in one embodiment of the search engine according to the invention as shown in FIG. 4, as follows. Although illustrated as separate servers, the same functions can be arranged or divided in different ways to run on different numbers of servers or as different numbers of processes, or be run by different organisations. Hence the use of the term server is not intended to limit to a single processor at a single location, a server can represent a function or functions which are distributed over multiple processors at different locations for example, or multiple servers can be implemented on a single processor.
a) A query server 50 that handles search queries from desktop PCs and mobile devices, passing them onto the other servers, and formats response data into web pages customised to different types of devices, as appropriate. Optionally the query server can operate behind a front end to a search engine of another organization at a remote location. Optionally the query server can carry out ranking of search results, or this can be carried out by a separate ranking server. In principle the functions of receiving of queries and returning search results need not be carried out at the same place, they can be distributed.
b) A web crawler 80 or crawlers to traverse the World Wide Web, loading web pages as it goes into a web mirror database, which is used for later indexing and analyzing. It controls which websites are revisited and how often, to enable changes in occurrences to be detected. This server can be arranged to maintain web collections which can represent portions of the web in the form of lists of URLs of pages or websites to be crawled. The crawlers are well known devices or software and so need not be described here in more detail.
c) An index server 35 that builds a searchable index of all the web pages in the web mirror, stored in the index, this index containing relevancy ranking information to allow users to be sent relevancy-ranked lists of search results. This is usually indexed by ID of the content and by keywords contained in the content.
d) A server 39 for user created search results, to control the process of enabling the user to create the mobile web version, store it as a user search result, and allow further sharing. Optionally the functions of the sharing server can be carried out by this server.

Web server programs are integral to the query server and the web crawler servers in some cases. These can be implemented to run Apache™ or some similar program, handling multiple simultaneous HTTP and FTP communication protocol sessions with users connecting over the Internet. The query server is connected to a database 70 that stores detailed device profile information on mobile devices and desktop devices, including information on the device screen size, device capabilities and in particular the capabilities of the browser or micro browser running on that device. The database may also store individual user profile information, so that the service can be personalised to individual user needs. This may or may not include usage history information.

The search engine can be a system 103 as shown comprising the web crawler, the index server, the user created search result server, and the query server. It takes as its input a search query request from a user, and returns as an output a prioritised list of search results. Relevancy rankings for these search results are calculated by the search engine by a number of alternative techniques as will be described in more detail.

Certain kinds of content e.g. web pages, can be ranked by existing techniques already known in the art, and multimedia content e.g. images, audio, or mobile specific pages, can be ranked differently for example. The type of ranking can be user selectable. For example users can be offered a choice of searching by conventional citation-based measures e.g. Google's™ PageRank™ or other measures.

In another embodiment, new candidate search results can be constructed by extracting content from more than one source page. This would involve being able to visit multiple source pages selectively collecting objects per source page.

In another embodiment, new content items can be constructed from alternative data sources (i.e. not just limited to source HTML pages). For example, an RSS feed could be presented with a simple graphical representation and objects (e.g. the title, link or body fields) being available for use in a content item. Alternatively, a database table viewer could be provided to enable cells or rows within a table to be used. In other words, the technique of creating new candidate search results does not need to be limited to extracting snippets of HTML.

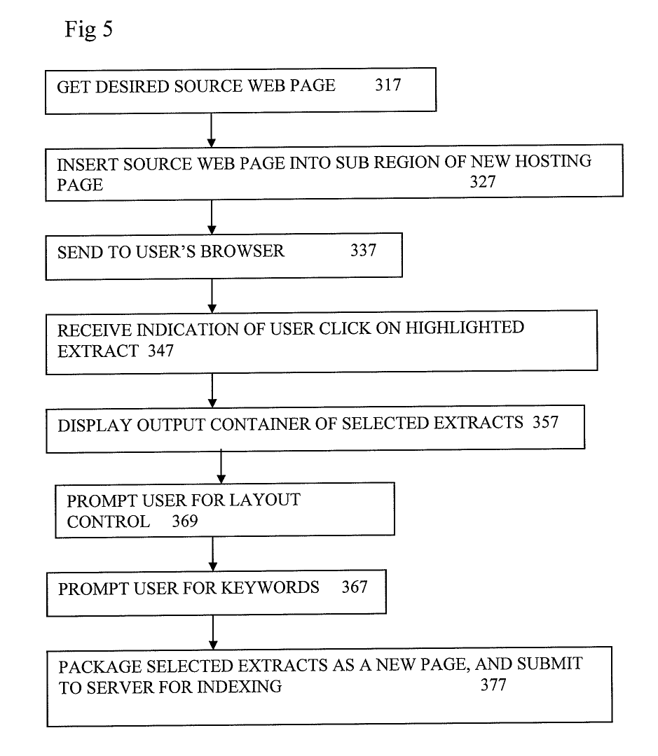

FIG. 5, Embodiment for Use with Browser

FIG. 5 shows operational steps of an embodiment of a search service for use with a user's browser without needing a plug in. At step 317 a desired source web page is requested by the user and is accessed by the service. At step 327 the source web page is inserted into a sub region of the new hosting page. This can enable the source to be manipulated or processed more easily. This page is sent to the user's browser at step 337. Extracts suitable for a mobile version can be highlighted to assist the user. The user selects an extract by clicking, and an indication of the user click is received by the search service at step 347. The service displays an output container showing the selected extracts at step 357.

The service can prompt a user for layout control inputs at step 369, and act on them as appropriate. Similarly, the user can be prompted for keywords as shown at step 367. At step 377 the service can package the selected extracts for the mobile version as a new page, which can be submitted for indexing.

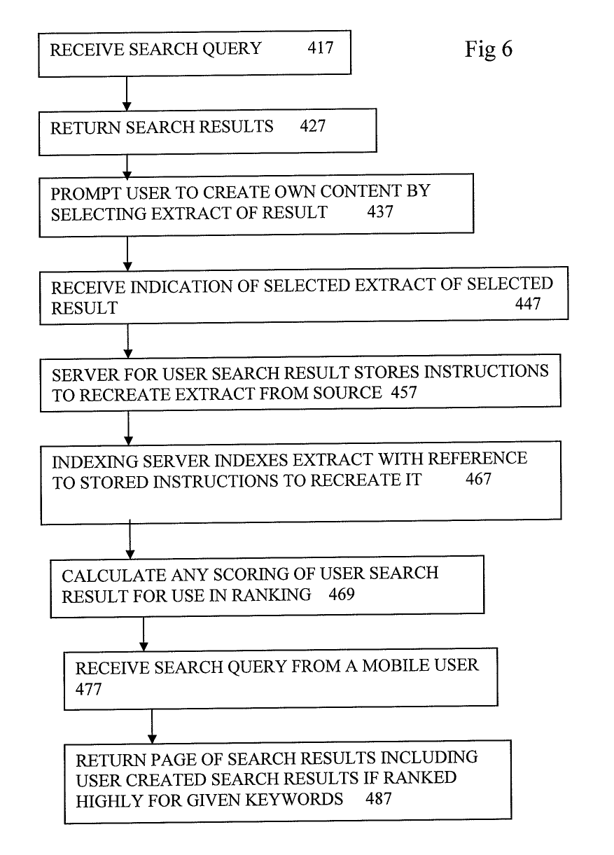

FIG. 6, Embodiment Using Search Result as Source and Storing as Instructions

FIG. 6 shows an embodiment showing operational steps involving using a search result as a source of user created result, and storing the user created result in the form of instructions to enable the extract to be recreated. These features may be implemented separately and combined with other features. The search service receives a search query at step 417, and search results are returned at step 427. At step 437, the service prompts the user to create their own content by selecting an extract of the results. The user may be carrying out a desktop search, and selecting an extract to create a mobile web version. The service receives the user selection at step 447. At step 457 the server for the user search results stores the extract in the form of instructions to enable the extract to be recreated on the fly. This can for example involve instructions to access the source, and identify where in the source to find the extract, and any instructions to modify the extract.

At step 467 the indexing server indexes the extract with reference to the stored instructions for recreating it. At step 469 any scoring of the user search result is carried out. Later, at step 477 a search query is received from another user, a mobile user. The service returns a page of search results including user created search results if ranked highly enough, and recreated on demand from the stored instructions at step 487.

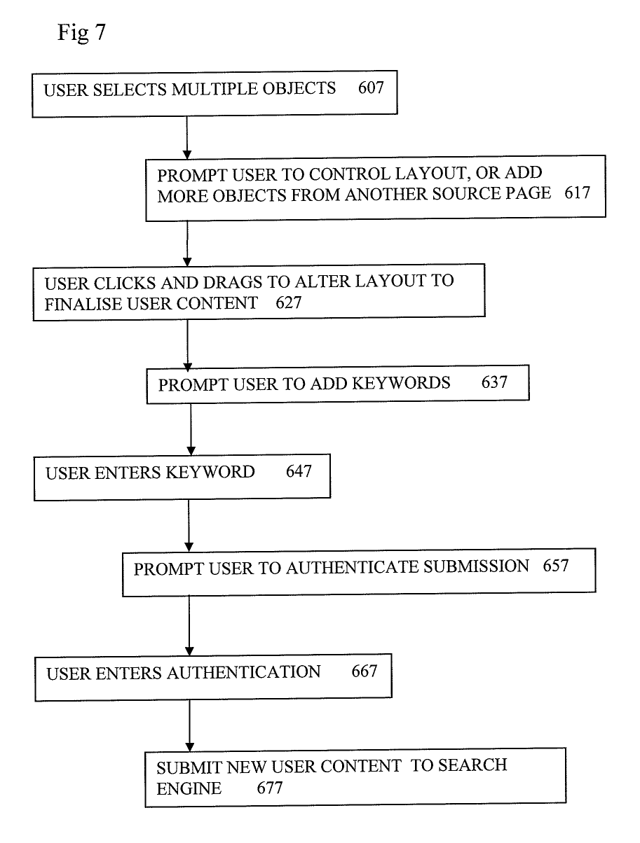

FIG. 7, Embodiment having Layout Control and Authentication

In the embodiment of FIG. 7 a user selects multiple objects at step 607 for incorporation in a mobile web version. The service prompts the user at step 617 to control the layout or add more objects from another source page. This can be controlled by the query server, or by the server for user created search results, or by software at the user device, as described above. The user clicks and drags objects to alter the layout of the mobile web version, at step 627. The user can optionally be prompted to add keywords at step 637, to supplement any keywords which can be derived automatically from the extract. The user enters any such keywords at step 647.

Possibilities for abuse of the service described so far also need addressing. As so far described, it would be possible to write robots (automated scripts) to create large numbers of these new candidate search results and hence potentially spoil their usefulness to legitimate users. In one solution to this problem, every item submission page can present a machine-unreadable human-readable image of a password (so called CAPTCHA™) that must be supplied correctly to authenticate the submission. In another solution, only registered and logged in users may submit content.

As shown in step 657 the user is prompted to authenticate the submission in any way. The user enters authentication at step 667, and the new user content is then submitted for indexing by the search engine.

In another solution, all submissions are allowed, but search ranking is used to promote the submissions of the user him/herself and those of his/her friends (and the friends of his/her friends etc). In another solution, it is recognised that popular objects (individual components of source pages, e.g. an image or a paragraph of text) will be submitted more than once by multiple users. This multiplicity can be used in the search result ranking to promote content items containing popular objects.

In a further embodiment, any of the services described so far could be deployed in a desktop-only service. Although this invention is of particular relevance to the constraints and problems of mobile browsing and searching, the idea that users can extract and define new candidate search results (as well as tag and share them) can be applied to desktop scenarios.

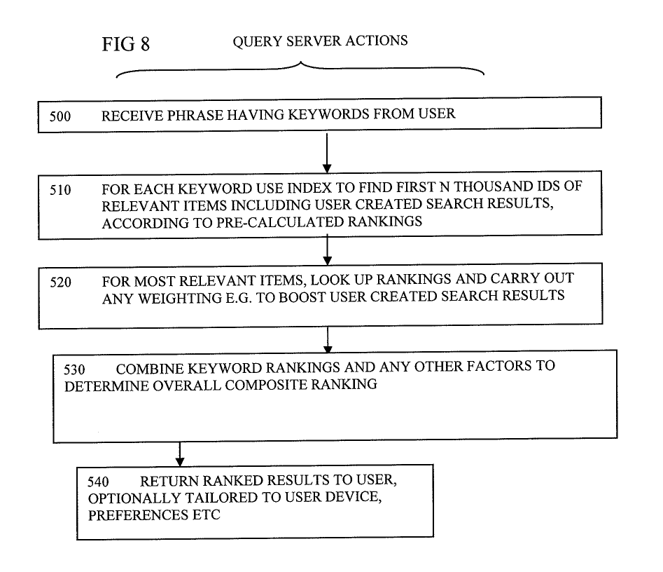

Query Server Action FIG. 8

Another embodiment of actions of a query server is shown in FIG. 8. In this example, a phrase having keywords is received from a user at step 500. At step 510, the query server uses an index to find the first n thousand IDs of content items relevant to keywords, in the form of documents or multimedia files (hits), according to pre-calculated rankings. At step 520, for the most relevant items, ranking scores are looked up and weighted as appropriate, for example to promote user created search results. At step 530, the query server uses keyword rankings, and any other factors to determine a composite ranking. The query server returns ranked results to the user, optionally tailored to user device, preferences etc at step 540.

The query server can be arranged to enable more advanced searches than keyword searches, to narrow the search by dates, by geographical location, by media type and so on. Also, the query server can present the results in graphical form to show mentions scores profiles for one or more content items. Another option can be to present indications of the confidence of the results, such as how frequently relevant websites have been revisited and how long since the results were crawled, or other statistical parameters.

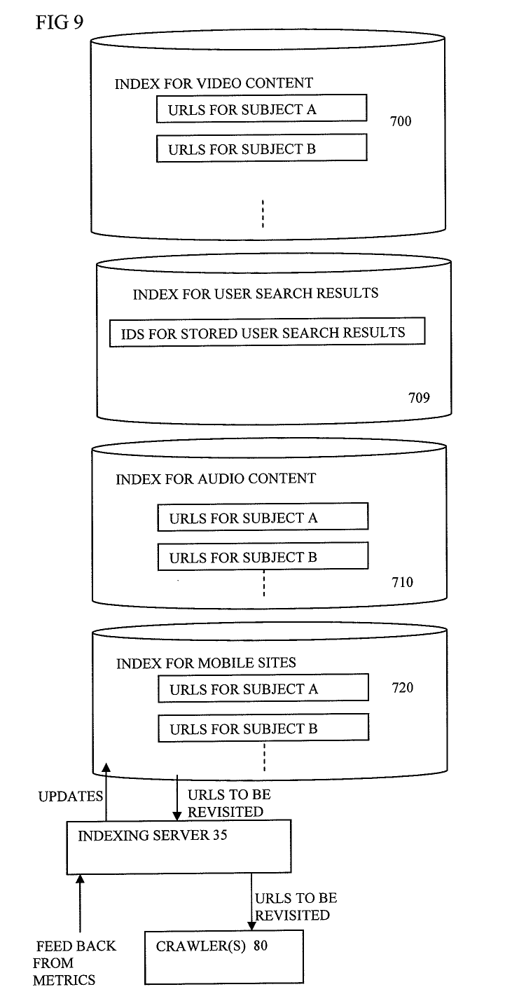

Web Collections, FIG. 9

An additional feature of some embodiments is a web collections server arranged to determine which websites on the world wide web to revisit and at what frequency, to provide content items to the search engine. The web collections server can be arranged to determine selections of websites according to any one or more of: media type of the content items, subject category of the content items and the record of content items or mentions associated with the websites. The search results can comprise a list of content items, such as titles and URLs, or richer summaries of them, and an indication of rank of the listed content items in any form. This can help enable the search to return more relevant results.

FIG. 9 shows an example of indexes for different web collections. Three web collections are shown, there could be many more. A web collection for video content has a keyword index comprising lists of URLs of pages or preferably websites according to subject, in other words different categories of content, for example sport, pop music, shops and so on. A second web collection for audio content, likewise has a keyword index 710 comprising lists of URLs for different subjects. A third web collection for mobile sites again has an index 720 comprising lists of URLs for different subjects. The web collections are for use where there are so many content items that it is impractical to revisit all of them to update the index. Hence the web collections are a representative selection of popular or active websites which can be revisited more frequently, but large enough to enable changes to be monitored accurately. The indexes can be implemented as logically distinct indexes, with different rules for the information stored, but physically implemented as a single index.

The index server 35 can build and maintain the indexes of the web collections to keep them representative, and can control the timing of the revisiting. For different media types or categories of subject, there may be differing requirements for frequency of update, or of size of web collection. The frequency of revisiting can be adapted according to feedback such as which websites change frequently, or which rank highly by mentions score, or backlink rankings. The updates may be made manually. To control the revisiting, the indexing server feeds a stream of URLs to the web crawlers, and can rescan the crawled pages for changes in content items.

After a set period, the pages in a given web collection are rescanned to determine their changes, and keep the index up to date, at least for that web collection. The web collections are selected to be representative. Embodiments may have any combination of the various features discussed, to suit the application. A summary of the indexing operation for such an embodiment is as follows.

Step 1: determine a web collection of web sites to be monitored. This web collection should be large enough to provide a representative sample of sites containing the category of content to be monitored, yet small enough to be revisited on regular and frequent (e.g. daily) basis by a set of web crawlers.

Step 2: set web crawlers running against these sites, and create web mirror containing pages within all these sites.

Step 3: During each time period, scan files in web mirror, for each given web page identify file categories (e.g. audio midi, audio MP3, image JPG, image PNG) which are referenced within this page.

Step 4: For each category, apply the appropriate analyzer algorithm which reads the file, and identifies separate content items from the page.

Step 5: Index the content items.

Other Features

In an alternative embodiment, the search is not of the entire web, but of a limited part of the web or a given database. In another alternative embodiment, the query server also acts as a metasearch engine, commissioning other search engines to contribute results (e.g. Google™, Yahoo™, MSN™) and consolidating the results from more than one source.

In an alternative embodiment, the web mirror is used to derive content summaries of the content items. These can be used to form the search results, to provide more useful results than lists of URLs or keywords. This is particularly useful for large content items such as video files. They can be stored along with the fingerprints, but as they have a different purpose to the keywords, in many cases they will not be the same. A content summary can encompass an aspect of a web page (from the world wide web or intranet or other online database of information for example) that can be distilled/extracted/resolved out of that web page as a discrete unit of useful information. It is called a summary because it is a truncated, abbreviated version of the original that is understandable to a user.

Example types of content summary include (but are not restricted to) the following:
Web page text—where the content summary would be a contiguous stretch of the important, information-bearing text from a web page, with all graphics and navigation elements removed.
News stories, including web pages and news feeds such as RSS—where the content summary would be a text abstract from the original news item, plus a title, date and news source.
Images—where the content summary would be a small thumbnail representation of the original image, plus metadata such as the file name, creation date and web site where the image was found.
Ringtones—where the content summary would be a starting fragment of the ringtone audio file, plus metadata such as the name of the ringtone, format type, price, creation date and vendor site where the ringtone was found.
Video Clips—where the content summary would be a small collection (e.g. 4) of static images extracted from the video file, arranged as an animated sequence, plus metadata

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The query server, and servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

1. A system arranged to incorporate content created by a user, the system having a user interface to interact with the user while they are accessing an existing online content item to create a mobile web version of at least a portion of that existing online content item, and an indexing part arranged to store and index the user created mobile version as a user created search result, retrievable by the system in response to a search query.

2. The system of claim 1, the user created search result being formatted as a portion of a web page, and the user interface being arranged to constrain a size and text format of the mobile web version so that the portion can reasonably be viewed on a screen of a hand held mobile device.

3. The system of claim 1, the user interface being arranged to cooperate with a browser of the user to prompt a user to select an extract of a web page being presented by the browser.

4. The system of claim 1, the user interface being arranged to combine a number of extracts of the existing online content item to form the mobile web version.

5. The system of claim 4, the user interface being arranged to enable user control of layout of the extracts in the mobile web version.

6. The system of claim 1, the indexing part being arranged to store the user created search result in the form of instructions to retrieve an online accessible source content item, and to extract a given part of it to recreate the user created search result.

7. The system of claim 1, the indexing part being arranged to store the user created search result as a content summary.

8. The system of claim 3, the user interface being arranged to cooperate with the browser on the device of the user to highlight prospective extracts for the user to select.

9. The system of claim 1, having a sharing part arranged to enable the user to share the user created content with a given other user.

10. A method of offering a search service incorporating content created by a user, the method having the steps of interacting with the user while they are accessing an existing online content item to enable the user to create a mobile web version of at least a portion of that existing online content item, and storing and indexing the mobile web version as a user created search result so as to be retrievable when the search service responds to a search query.

11. The method of claim 10, the user created search result comprising a portion of a web page, and the interacting step involving constraining a size and text format of the mobile web version so that the portion can reasonably be viewed on a screen of a hand held mobile device.

12. The method of claim 10, the interacting step involving cooperating with a browser of the user to prompt a user to select an extract of a web page being presented by the browser.

13. A method of using a search service incorporating content created by a user, the method having the steps by a user of accessing an existing online content item, interacting with the search service to create a mobile web version of at least a portion of that existing online content item, and causing the search service to store and index the mobile web version as a user created search result so as to be retrievable when the search service responds to a search query.

14. A program on a physical medium and executable by computing hardware so as to provide a system arranged to incorporate content created by a user, the system having a user interface to interact with the user while they are accessing an existing online content item to create a mobile web version of at least a portion of that existing online content item, and an indexing part arranged to store and index the user created mobile version as a user created search result, retrievable by the system in response to a search query.
